(19) United States
(12) Patent Application Publication
(10) Pub. No.: US 2002/0138836 A1
(43) Pub. Date: Sep. 26, 2002

(54) Method and apparatus for recommending television programming through a celebrity or using a celebrity profile

(75) Inventor: John Zimmerman, Ossining, NY (US)

Correspondence Address: Corporate Patent Counsel, U.S. Philips Corporation, 580 White Plains Road, Tarrytown, NY, 10591, US

(73) Assignee: koninklijke Philips Electronics N.V.

(21) Appl. No.: 09/815,856

(22) Filed: Mar. 23, 2001

(51) Int. Cl. H04N 5/445; G06F 3/00; H04N 7/025

(52) U.S. Cl. 725/46; 725/34

(57) ABSTRACT

A method for making a recommendation in a lifestyle recommendation machine. The method includes the steps of: generating a user profile based on explicit and/or implicit directions of a user; making a recommendation for an item, service, and/or event based on the user profile; and reporting the recommendation to the user through an agent, where the agent is preferably a celebrity. In another embodiment the method includes the steps of: substituting a user profile based on explicit and/or implicit directions of a user with a celebrity profile of a celebrity; making a recommendation for an item, service, and/or event based on the celebrity profile; and reporting the recommendation to the user.

### BACKGROUND OF THE INVENTION

1. Field of the Invention

The present invention relates generally to devices which employ a user profile (referred to hereinafter as a “lifestyle recommendation device”) and, more particularly, to television programming devices for learning a user's profile through the user's recording and viewing habits in which the user's profile can be replaced with a celebrity's profile or in which a celebrity can deliver the recommendation of the lifestyle recommender to the user.

2. Prior Art

Rapid growth in communication technology has lead to an increase in the number of celebrities. At the same time this growth has been matched by an increase in content. More ways to communicate have lead to more content, and more content means more celebrities. More content also makes it more difficult for people to find something to watch or listen to. Those in the art have addressed this problem through personalization. They have and continue to develop television programming devices that find and recommend content based on user profiles.

Currently many devices, not just those that recommend television programming, use personal profiles. For instance a lifestyle recommendation device can also be used in the areas of music, movies, and fashion. These lifestyle recommendation devices allow users to customize the environment or in some cases the devices can even learn what users like by observing the user's behavior. One such product is used to learn and record television programming based on the user's viewing and recording habits. From the user's viewing and recording habits, the device learns a profile of the user from which the device automatically records and/or recommends television programming it thinks the user will like.

Lifestyle recommendation devices build a user's profile in three ways. Firstly, the user can explicitly enter what his or hers likes and dislikes are. Secondly, a user can enter feedback regarding a specific event, item, or content, such as a television movie. Thirdly, the device can implicitly build a user's profile based on the user's observed behavior.

Typically, such as is the case in a television programming recommendation device, the device will recommend a particular television program with a number associated with the program. For instance, depending upon how well a particular television movie fits within the user profile, the device may assign it an 8 (out of a possible 10), indicating to the user that, based on the user's explicit and/or implicit behavior, the movie should be favorable.

Traditionally people have turned to celebrities to help them find content. Music, movie, and TV stars appear in magazines and on talk shows where they promote their latest projects. Popular disc and video jockeys recommend the music they play. Celebrity critics rate movies, music, and TV shows. Even TV Guide, a magazine that list TV shows for the following week, sells itself to readers through the celebrities that appear on the cover. Celebrities are the content, and celebrities sell the content.

In his 1961 book The Image, Daniel Boorstin defined celebrities as people well known for their “well-knowness”. This definition works well, because it captures the most important aspect of being a celebrity, not being forgotten. However, it falls short because it limits celebrities to people. Instead, for the purpose of this disclosure, celebrities are well known characters and in addition to real life people can also include fictional and synthetic celebrities.

Real celebrities appear more like characters than like people. Consider Tom Cruise and Tom Hanks for example. These popular celebrities command high salaries because they guarantee a strong box office draw, and that success comes from the consistent delivery of a character. Tom Cruise typically plays a character which is “the best.” He is the best spy, the best fighter pilot, the best brother, or the best bartender. Tom Hanks is a “regular guy” who encounters extraordinary circumstances. He is a regular guy who falls in love with a mermaid, a regular prison guard who witnesses miracles, or a regular guy of lower intelligence who leads an incredible life. When people decide to go to a Tom Hanks or a Tom Cruise movie, they know what character to expect.

The fictional character James Bond also works at this level. He is just as much a celebrity as the actors who have played him. When people say they are going to a Tom Cruise movie, it has the same value as saying they are going to a James Bond movie.

From these examples it is easy to see celebrities as products, however the fact that they are part of a story makes them more desirable. Simba, the heroic, animated lion from Disney's The Lion King, offers a good example of a “character” celebrity. This movie generated billions of dollars in film and video release and merchandise. People did not want to own just any stuffed lion, they wanted to own Simba. They wanted to participate in the story, and that is what makes celebrities characters and not just products.

Finally there is the synthetic celebrity, such as Lara Croft, the main character in the Tomb Raider video game. She appears on the cover of magazines, has web sites devoted to her, and her fans write fictional accounts of her adventures. She is not a person, but she is a well-known character, a synthetic celebrity.

The lifestyle recommendation devices of the prior art do not provide a user with the alternative of replacing the user profile with that of a celebrity's profile, real, fictional, or synthetic. Furthermore, the lifestyle recommendation devices of the prior art can only recommend an item, event, or programming through the use of a weighted number which does not always catch the attention of a user. In view of the prior art, there is a need for a lifestyle recommendation device, which resolves these and other problems with the prior art. In summary, there is a need in the art for a lifestyle recommendation device which takes advantage of the importance of celebrities in our society.

### SUMMARY OF THE INVENTION

Therefore it is an object of the present invention to provide a lifestyle recommendation device and method for its operation which addresses the problems of the prior art.

People create celebrities because they fulfill a human need for relationships. These are safe, one-way, relationships, where people can select and dump celebrities without any fear of being dumped. Celebrities offer opportunities for many types of relationships, but with respect to a lifestyle recommendation device. It is important to consider identification and common experience.

People form relationships with celebrities they identify with. They attach their identity to the identity of the star with the hope of rising as the celebrity rises. This phenomenon can easily be observed in rock music fans. Fans want to be identified as having liked a band before they struck it rich. That way they can be identified as having “risen” with the band's fame. It can also be seen in sports fans who feel they have won when the team they cheer for wins.

People begin and grow these relationships by allowing celebrities to influence them. A great deal of work has been done in the medical community on the effectiveness of celebrity influence based on dissemination of information. There is clear evidence that people take actions based on celebrities. In a study on Magic Johnson and HIV information, researchers discovered people were more willing to accept the advice from a celebrity, Magic Johnson, than the advice of experts.

Celebrities not only help form relationships between themselves and people; they also form relationships among the people who follow the celebrity. Celebrities offer a common experience people share with each other. “Instead of gossiping over the back fence about our neighbor, we now gossip with strangers about other strangers [celebrities] all over the world.” As the world fractionalizes more and more with communication options, celebrities offer a common point of reference.

Common experience with celebrities allows people to communicate. For example: when a person states that they like Tom Cruise and hate Pamela Anderson, they are communicating a lot about themselves to an audience that is familiar with those celebrities. They are defining themselves by the characters those celebrities play.

A journalist wrote what she considered an honest yet unflattering article about a pop band. She received numerous pieces of “hate mail”. She did not know why people were more interested in defending this group than in hearing the truth. People went out of their way to protect their relationship because they were really protecting themselves.

Accordingly, a first embodiment of a method for making a recommendation in a lifestyle recommendation machine is provided. The method comprises the steps of: generating a user profile based on explicit and/or implicit directions of a user; making a recommendation for an item, service, and/or event based on the user profile; and reporting the recommendation to the user through an agent.

Preferably, the recommendation is a recommendation of television programming and the agent is a celebrity. More preferably, the reporting step comprises displaying a video of the agent and playing accompanying audio which announces the recommendation. Alternatively, the reporting step comprises displaying a still image of the agent and either displaying a textual message which announces the recommendation or playing accompanying audio which announces the recommendation.

Also provided is a first embodiment of a lifestyle recommendation device. The device comprises: means for generating a user profile based on explicit and/or implicit directions of a user; means for making a recommendation for an item, service, and/or event based on the user profile; and reporting means for reporting the recommendation to the user through an agent. Preferably, the lifestyle recommendation device is a television programming storage device and the agent is a celebrity.

Still yet provided are a computer program product for carrying out and storing the method steps of the present invention and a program storage device for storing the same.

Still yet further provided is a second embodiment of a method for making a recommendation in a lifestyle recommendation machine. The method comprises the steps of: substituting a user profile based on explicit and/or implicit directions of a user with a celebrity profile of a celebrity; making a recommendation for an item, service, and/or event based on the celebrity profile; and reporting the recommendation to the user. Preferably, the substituting step comprises downloading the celebrity profile from an external source.

More preferably, the reporting step comprises reporting the recommendation to the user through an agent, such as the celebrity. The celebrity preferably reports the recommendation by displaying a video of the celebrity and playing accompanying audio which announces the recommendation. Alternatively, the celebrity can report the recommendation by displaying a still image of the celebrity and either displaying a textual message which announces the recommendation or playing accompanying audio which announces the recommendation.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a flow chart illustrating a first embodiment of the methods of the present invention.

FIG. 2 illustrates a flow chart illustrating a second embodiment of the methods of the present invention.

FIG. 3 illustrates a lifestyle recommendation apparatus useful in carrying out the methods of FIGS. 1 and 2.

### DETAILED DESCRIPTION OF THE PREFERRED EMBODIMENT

Although this invention is applicable to numerous and various types of lifestyle recommendation devices, it has been found particularly useful in the environment of television programming. Therefore, without limiting the applicability of the invention to television programming, the invention will be described in such environment.

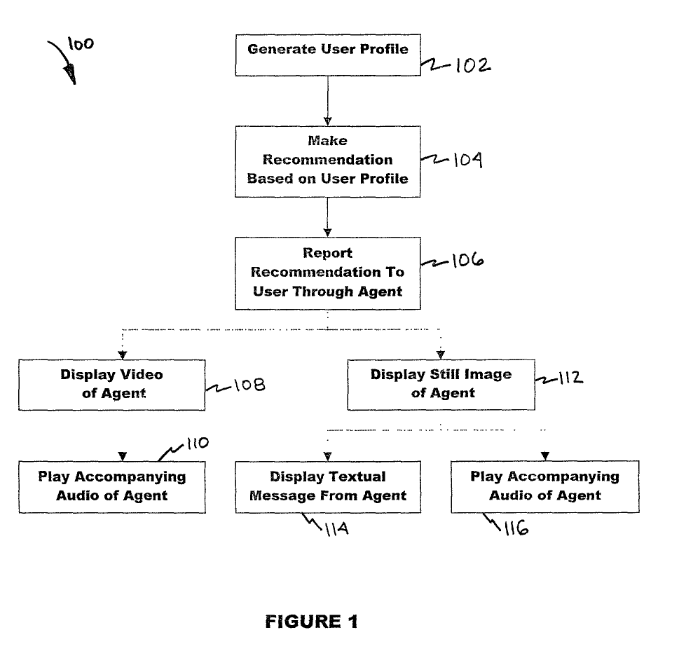

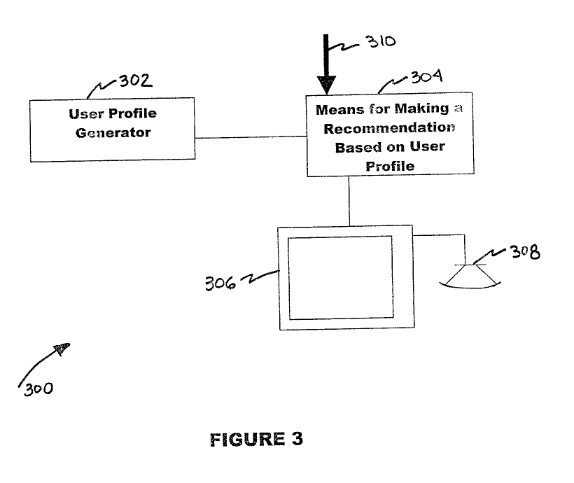

Referring now to FIGS. 1 and 3, a first embodiment for making a recommendation in a lifestyle recommendation machine will be discussed where FIG. 1 illustrates a method for making a recommendation in a lifestyle recommendation machine and FIG. 3 illustrates a schematic illustration of the lifestyle recommendation machine for carrying out the method of FIG. 1. The method being generally referred to by reference numeral 100, the machine by reference numeral 300.

At step 102, a user profile is generated in a user profile generation means 302 based on explicit and/or implicit directions of a user. Such means is well known in the art and include commercial devices such as TiVo® manufactured by Philips Electronics which makes recommendations regarding television programming. At step 104, a recommendation is made for an item, service, and/or event based on the user profile, such as a recommendation for television programming. Means for making such a recommendation 304 are also well known in the art and also include the TiVo® device previously discussed.

Instead of reporting the recommendation to a user as a number as is done in the prior art, at step 106, the method and apparatus of the present invention reports the recommendation to the user through an agent. The agent is preferably a celebrity, which as defined above can be real, fictional, and synthetic. However, a non-celebrity, such as a spouse, friend, or relative can also act as the agent who reports the recommendation to the user.

Preferably, the reporting step 106 is done by displaying a video of the agent on a monitor 306 while playing an accompanying audio on a speaker 308 which announces the recommendation. Displaying the video of the agent and playing an accompanying audio announcement are shown in FIG. 1 as steps 108 and 110, respectively. Alternatively, the reporting step 106 can be done by displaying a still image of the agent on the monitor 306 and either also displaying a textual message on the monitor 306 which announces the recommendation or playing accompanying audio on the speaker 308 which announces the recommendation. Displaying the still image of the agent and an either displaying an accompanying textual message or playing an accompanying audio announcement are shown in FIG. 1 as steps 112, 114, and 116, respectively. In the case of a television recommendation device, the monitor 306 is preferably a television monitor connected to the device and the speaker 308 is integral with the television monitor.

Those skilled in the art will appreciate that the first embodiment of the methods and apparatus of the present invention replace the mundane and meaningless reporting methods of the prior art with a reporting of the user's preferences through an agent such as a celebrity. People have the tradition of receiving content recommendations from celebrities, such as in commercials or talk show appearances. Presenting computer content recommenders as celebrities fulfills a users' expectations. The celebrities are content; they live in the world of their own recommendations. By making recommenders celebrities, consumer electronics products can transform from content delivery devices into actual content.

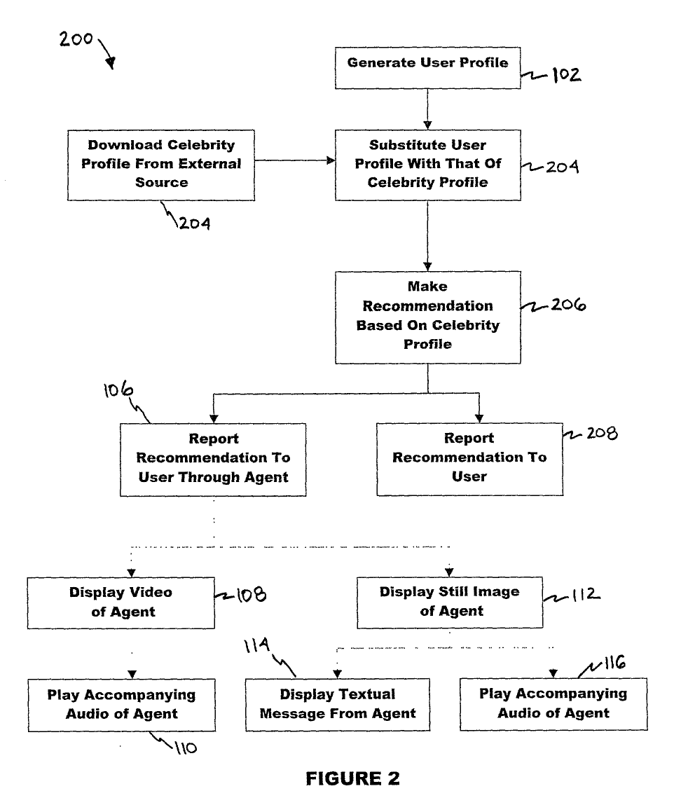

Referring now to FIGS. 2 and 3,a second embodiment for making a recommendation in a lifestyle recommendation machine will be discussed where FIG. 2 illustrates a method for making a recommendation in a lifestyle recommendation machine and FIG. 3 illustrates the lifestyle recommendation machine for carrying out the method of FIG. 2. The method being generally referred to by reference numeral 200, the machine by reference numeral 300.

At step 102, as in the method of FIG. 1, a user profile is generated by the user profile generation means 302. At step 202, the user profile is substituted with a celebrity profile of a celebrity, real, fictional, or synthetic. The celebrity profile is preferably downloaded at step 204 via a data link 310 to the means for making the recommendation 304 from a URL address or from another external source. However, celebrity profiles can also be stored internally on the means for making the recommendation 304 and can be chosen by the user by way of a screen menu or other means known in the art.

At step 206 a recommendation is made by the means for making a recommendation 304 for an item, service, and/or event, such as a recommendation for television programming based on the celebrity profile. At step 208, the recommendation is made to the user by any means known in the art, such as reporting a numerical grade to the user which reflects the likelihood that the user would approve of the recommendation.

Alternatively, the lifestyle recommendation device can report the recommendation to the user through steps 108-116 as discussed above with regard to FIG. 1. Specifically, a video or still image of the celebrity can be displayed on the monitor 308 and either an accompanying audio message on the speaker 308 or a displayed textual message also on the monitor 306 can announce the recommendation of the celebrity.

Those skilled in the art will appreciate that the second embodiment of the methods and apparatus of the present invention replace recommendations based on a user's profile with that of a celebrity's profile with whom the user may have a special relationship. Computer agents can have relationships with people that are better than real celebrities. The relationship can be safe, but it can be personalized to the individual. The celebrity can learn about the user and reflect that knowledge in the interactions. By keeping the core personality of the celebrity the same, the content recommenders of the present invention can provide personal information while still creating a common experience for many users.

Finally, people trust celebrities. Celebrity computer agents might earn the same trust. And trust makes a recommendation device that people want to use.

The methods of the present invention are particularly suited to be carried out by a computer software program, such computer software program preferably containing modules corresponding to the individual steps of the method. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for making a recommendation in a lifestyle recommendation machine, the method comprising the steps of:
generating a user profile based on explicit and/or implicit directions of a user;
making a recommendation for an item, service, and/or event based on the user profile; and
reporting the recommendation to the user through an agent.

2. The method of claim 1, wherein the recommendation is a recommendation of television programming.

3. The method of claim 1, wherein the agent is a celebrity.

4. The method of claim 1, wherein the reporting step comprises displaying a video of the agent and playing accompanying audio which announces the recommendation.

5. The method of claim 1, wherein the reporting step comprises displaying a still image of the agent.

6. The method of claim 5, wherein the reporting step further comprises displaying a textual message which announces the recommendation.

7. The method of claim 5, wherein the reporting step further comprises playing accompanying audio which announces the recommendation.

8. A lifestyle recommendation device comprising:
means for generating a user profile based on explicit and/or implicit directions of a user;
means for making a recommendation for an item, service, and/or event based on the user profile; and
reporting means for reporting the recommendation to the user through an agent.

9. The device of claim 8, wherein the lifestyle recommendation device is a television programming storage device.

10. The device of claim 8, wherein the agent is a celebrity.

11. The device of claim 8, wherein the reporting means comprises means for displaying a video of the agent and playing accompanying audio which announces the recommendation.

12. The device of claim 8, wherein the reporting means comprises means for displaying a still image of the agent.

13. The device of claim 12, wherein the reporting means further comprises means for displaying a textual message which announces the recommendation.

14. The device of claim 12, wherein the reporting means further comprises means for playing accompanying audio which announces the recommendation.

15. A program storage device readable by machine, tangibly embodying a program of instructions executable by the machine to perform method steps for making a recommendation in a lifestyle recommendation machine, the method comprising the steps of:
generating a user profile based on explicit and/or implicit directions of a user;
making a recommendation for an item, service, and/or event based on the user profile; and
reporting the recommendation to the user through an agent.

16. A computer program product embodied in a computer-readable medium for making a recommendation in a lifestyle recommendation machine, the computer program product comprising:
computer readable program code means for generating a user profile based on explicit and/or implicit directions of a user;
computer readable program code means for generating making a recommendation for an item, service, and/or event based on the user profile; and
computer readable program code means for generating reporting the recommendation to the user through an agent.

17. A method for making a recommendation in a lifestyle recommendation machine, the method comprising the steps of:
substituting a user profile based on explicit and/or implicit directions of a user with a celebrity profile of a celebrity;
making a recommendation for an item, service, and/or event based on the celebrity profile; and
reporting the recommendation to the user.

18. The method of claim 17, wherein the substituting step comprises downloading the celebrity profile from an external source.

19. The method of claim 17, wherein the reporting step comprises reporting the recommendation to the user through an agent.

20. The method of claim 19, wherein the agent is the celebrity.

21. The method of claim 20, wherein the reporting step comprises displaying a video of the celebrity and playing accompanying audio which announces the recommendation.

22. The method of claim 20, wherein the reporting step comprises displaying a still image of the celebrity.

23. The method of claim 22, wherein the reporting step further comprises displaying a textual message which announces the recommendation.

24. The method of claim 22, wherein the reporting step further comprises playing accompanying audio which announces the recommendation.
